(19) United States
(12) Patent Application Publication
(10) Pub. No.: US 2009/0144458 A1
(43) Pub. Date: Jun. 4, 2009

(54) DONGLE DEVICE AND HOST DEVICE WITH MILLIMETER WAVE HOST INERFACE AND METHOD FOR USE THEREWITH

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/949,728

(22) Filed: Dec. 3, 2007

(51) Int. Cl. G06F 3/00; H04B 1/38; G06F 13/00

(52) U.S. Cl. 710/11; 455/73; 711/115; 711/E12.001

(57) ABSTRACT

A dongle device includes a flash memory and a millimeter wave transceiver that receives an RF signal from a host device, converts the RF signal into a power signal for powering the millimeter wave transceiver, demodulates the RF signal to receive read commands, write commands, and write data from the host device, and backscatters the RF signal based on read data. A host module decodes the read commands and the write commands from the host device, processes the read commands to retrieve the read data from the flash memory and processes the write commands to write the write data to the flash memory.

### CROSS-REFERENCE TO RELATED APPLICATIONS

Not applicable

### BACKGROUND OF THE INVENTION

1. Technical Field of the Invention

This invention relates generally to flash memory devices and integrated circuits used therein.

2. Description of Related Art

Communication systems are known to support wireless and wireline communications between wireless and/or wireline communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

In most applications, radio transceivers are implemented in one or more integrated circuits (ICs), which are inter-coupled via traces on a printed circuit board (PCB). The radio transceivers operate within licensed or unlicensed frequency spectrums. For example, wireless local area network (WLAN) transceivers communicate data within the unlicensed Industrial, Scientific, and Medical (ISM) frequency spectrum of 900 MHz, 2.4 GHz, and 5 GHz. While the ISM frequency spectrum is unlicensed there are restrictions on power, modulation techniques, and antenna gain.

As IC fabrication technology continues to advance, ICs will become smaller and smaller with more and more transistors. While this advancement allows for reduction in size of electronic devices, it does present a design challenge of providing and receiving signals, data, clock signals, operational instructions, etc., to and from a plurality of ICs of the device. Currently, this is addressed by improvements in IC packaging and multiple layer PCBs. For example, ICs may include a ball-grid array of 100-200 pins in a small space (e.g., 2 to 20 millimeters by 2 to 20 millimeters). A multiple layer PCB includes traces for each one of the pins of the IC to route to at least one other component on the PCB. Clearly, advancements in communication between ICs are needed to adequately support the forth-coming improvements in IC fabrication.

Flash memory devices such as NOR flash and NAND flash devices can provide non-volatile storage of digital data. These devices are implemented in a wide variety of host devices, particularly in data storage and firmware applications.

The limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 presents a pictorial representation of a dongle device and several examples of host devices in accordance with an embodiment of the present invention;

FIG. 2 presents a block diagram representation of a dongle device 60 in accordance with an embodiment of the present invention;

FIG. 3 presents a block diagram representation of a host interface module 1250 in accordance with an embodiment of the present invention;

FIG. 4 presents a flowchart representation of a method in accordance with an embodiment of the present invention;

FIG. 5 presents a block diagram representation of a protocol 1490 in accordance with an embodiment of the present invention;

FIG. 6 presents a block diagram representation of millimeter wave transceivers 1218 and 1260 in accordance with an embodiment of the present invention;

FIG. 7 presents a flowchart representation of a method in accordance with an embodiment of the present invention;

FIG. 8 presents a flowchart representation of a method in accordance with an embodiment of the present invention;

FIG. 9 presents a flowchart representation of a method in accordance with an embodiment of the present invention;

FIG. 10 presents a flowchart representation of a method in accordance with an embodiment of the present invention;

FIG. 11 presents a flowchart representation of a method in accordance with an embodiment of the present invention.

### DETAILED DESCRIPTION OF THE INVENTION

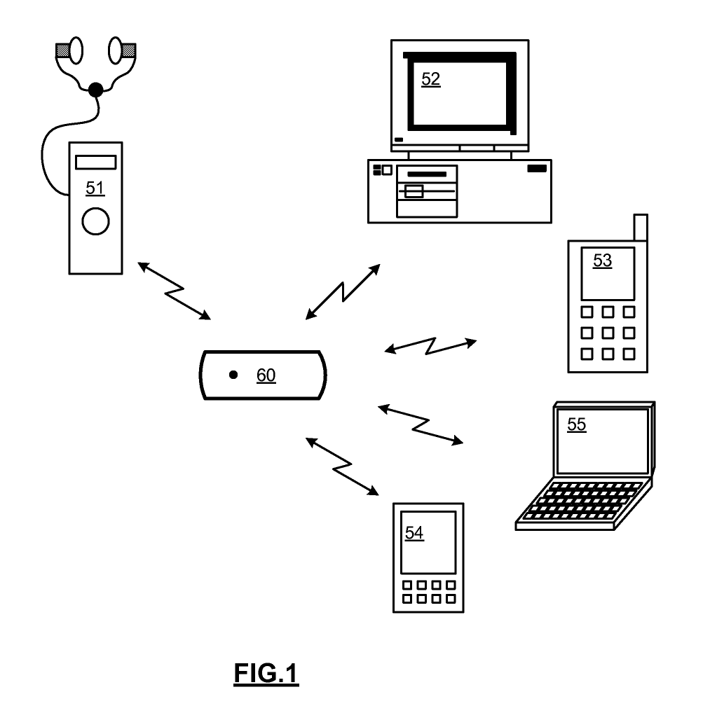

FIG. 1 presents a pictorial representation of a dongle device and several examples of host devices in accordance with an embodiment of the present invention. In particular, a dongle device 60, such as a thumb drive or other flash memory device couples selectively to a host device such as handheld audio unit 51, computer 52, wireless communication device 53, personal digital assistant 54 and/or laptop computer 55. Dongle device 60 includes a millimeter wave interface that wirelessly receives power from the host device and that wirelessly communicates data between the host device and the dongle device 60.

Dongle device 60 can be used in conjunction with handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

Dongle device 60 can be used in conjunction with computer 52 to provide data storage, or implement a security application or other application. Computer 52 can be a desktop computer, or an enterprise storage device such as a server of a host computer that is attached to a storage array such as a redundant array of independent disks (RAID) array, storage router, edge router, storage switch and/or storage director.

Dongle device 60 can be used in conjunction with wireless communication device 53 to provide general storage or storage of audio content such as motion picture expert group (MPEG) audio layer 3 (MP3) files or Windows Media Architecture (WMA) files, video content such as MPEG4 files, JPEG point photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

Wireless communication device 53 can be capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide streaming audio and/or video programming. In this fashion, wireless communication device 53 can place and receive telephone calls, text messages such as emails, short message service (SMS) messages, pages and other data messages that can include attachments such as documents, audio files, video files, images and other graphics.

Dongle device 60 can be used in conjunction with personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the personal digital assistant 54, emails, webpage information and other information downloaded from the Internet, address book information, and/or any other type of information that may be stored in a digital format.

Dongle device 60 can be used in conjunction with laptop computer 55 to provide general purpose storage for any type of information in digital format.

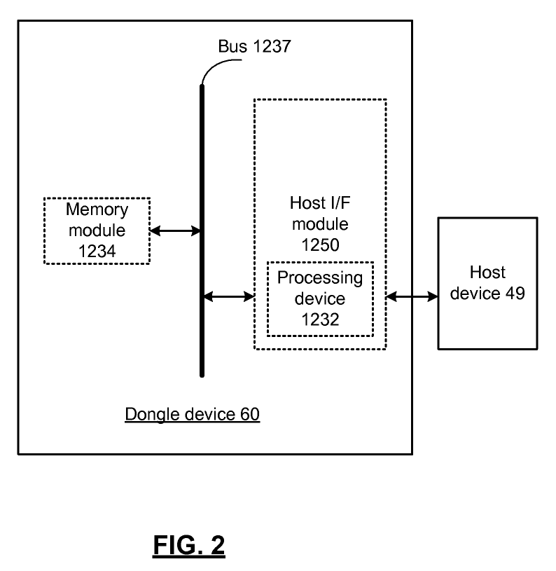

FIG. 2 presents a block diagram representation of a dongle device 60 in accordance with an embodiment of the present invention. In particular, dongle device 60 includes a memory module 1234, such as NOR, NAND or other flash memory. A host interface module 1250 couples the memory module to a host device 49, such as handheld audio unit 51 computer 52, wireless communication device 53, personal digital assistant 54, laptop computer 55 or other host device. In particular, host interface module 1250 includes a millimeter wave transceiver for wirelessly communicating with the host device 49. Host module interface module 1250 can include a processing device 1232 to arbitrate the execution of read and write commands and the flow of data between the host interface module 1250 and the memory module 1234. Processing device 1232 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 40 implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. In other embodiments, a separate processing device, coupled to bus 1237, or in an alternative configuration with or without bus coupling can be used for this purpose.

Host interface module 1250, as a whole, converts incoming data and commands from the host device 49 in the host interface protocol such as AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF), into data and commands, such as DMA or any of a variety of other formats that are used by dongle device 60 for this purpose. Conversely, data from read from memory module 1234 is converted by host interface module 1250 from the format used by memory module 1234 into the particular host interface protocol used by the host device 49. Host interface module 1250 can be implemented using hardware, software and/or firmware, depending, in particular on the implementation of processing device 1232.

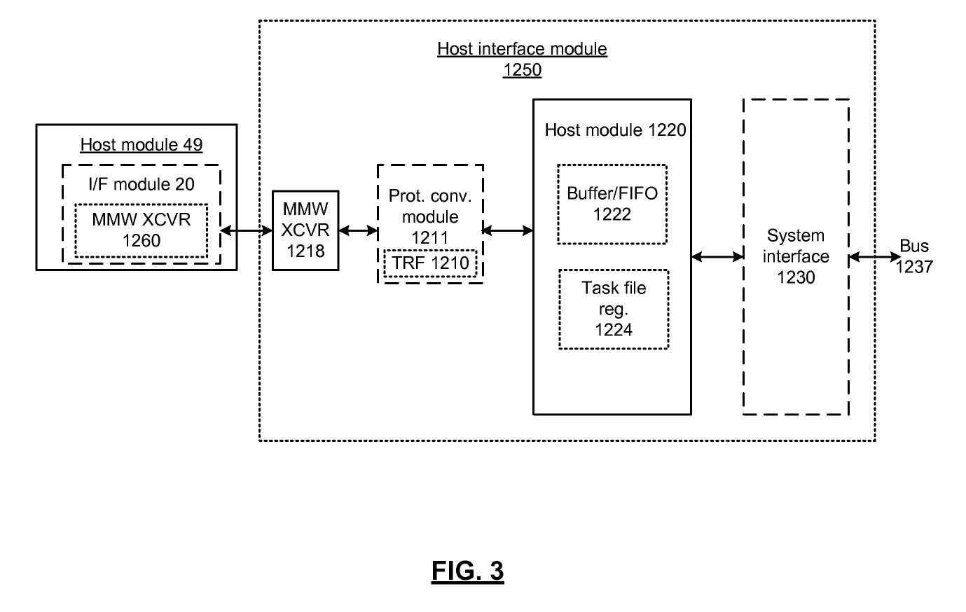

FIG. 3 presents a block diagram representation of a host interface module 1250 in accordance with an embodiment of the present invention. In particular, host interface module 1250 includes a millimeter wave transceiver 1218 coupled to wirelessly communicate read commands, write commands, read data and write data between the dongle device 60 and the host device 49, via interface module 20, over a millimeter wave communication path in accordance with a host interface protocol. Optional protocol conversion module 1211 is coupled to convert the read commands, the write commands and the write data from the host interface protocol and to convert the read data to the host interface protocol. Host module is coupled to decode the read commands and the write commands from the host device 49, to process the read commands to retrieve the read data from the memory module 1234 and to process the write commands to write the write data to the memory module 1234.

Host module 1220 can include a processing device, such as processing device 1232 to arbitrate the execution of read and write commands and the flow of data between the host interface module 1250 and the memory module 1234. Protocol conversion module 1211 with task file register 1210, host module 1220 with buffer/FIFO 1222 and task file register 1224, and optional system interface 1230 operate to read data from and write data to memory module 1234 based on commands, such as direct memory access commands, from host module 49.

The operation of host interface module 1250 can be viewed in terms of four fundamental operations with the host device 49: providing a physical layer interface to the host device, providing a link layer interface to the host device, providing a transport layer interface to the host device, and provide command decoding of commands from the host device. Protocol conversion module 1211 provides physical layer and link layer interface, and the host module 1220 provides command decoding and transport layer interface between the memory module 1234 and the host device 49 that is attached thereto. In an embodiment of the present invention, the host interface protocol operates in accordance with a protocol stack having a physical layer, a link layer, a command layer and a transport layer interface between the dongle device 60 and the host device 49. In particular, the physical layer and the link layer can operate in accordance with a millimeter wave protocol, such as an RFID protocol or other wireless protocol.

In an embodiment, protocol conversion module 1211 includes a task file register 1210, that can be written by the host device 49. The host module 1220 also includes a task file register 1224 that is copied from the task file register 1210. This synchronization of task file registers between the protocol conversion module 1211 and the host module 1220 allows commands to be passed from the host device 49. Task file register 1210 is implemented as specific locations in a memory of host interface module 1250 that store commands, such as for DMA transfers of a block of memory. In this implementation, the task file register 1210 contains an address field, such as a 16-bit address field and a count field, such as a 16-bit count field, and a data direction, that define the block of data to be transferred and whether the operation is for a read or write. Task file register 1224 of host module 1220 is similarly implemented. Host module 1220 further includes a buffer/FIFO 1222 that buffers the read and write commands from the host device 49 in a buffer order, such as a first-in-first-out order.

In operation, millimeter wave transceiver 1218 receives an RF signal from host device 49. Millimeter wave transceiver 1218 converts the RF signal into a power signal for powering the millimeter wave transceiver, demodulates the RF signal to receive read commands, write commands, and write data from the host device 49 and backscatters the RF signal based on read data. Host module 1220, by itself or with optional protocol conversion module 1211 and system interface 1230, decodes the read commands and the write commands from the host device 49, processes the read commands to retrieve the read data from the flash memory 1234 and to process the write commands to write the write data to the flash memory 1234. In an embodiment of the present invention, the millimeter wave transceiver 1218 is further coupled to demodulate the RF signal to receive an erase command from the host device 49, and the host module 1220 is further coupled to decode the erase command, and process the erase commands to erase data from the flash memory 1234.

Interface module 20 include a millimeter wave transceiver 1260 that transmits an RF signal for powering the dongle device 60, modulates the RF signal to send read commands, write commands, and write data to the dongle device 60, and demodulates backscattering of the RF signal to produce read data. In an embodiment of the present invention, the millimeter wave transceiver 1260 is further coupled to modulate the RF signal to send an erase command to the dongle device 60.

As discussed, the read commands and write commands can be formatted in accordance a host interface protocol such as direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF) or other protocol.

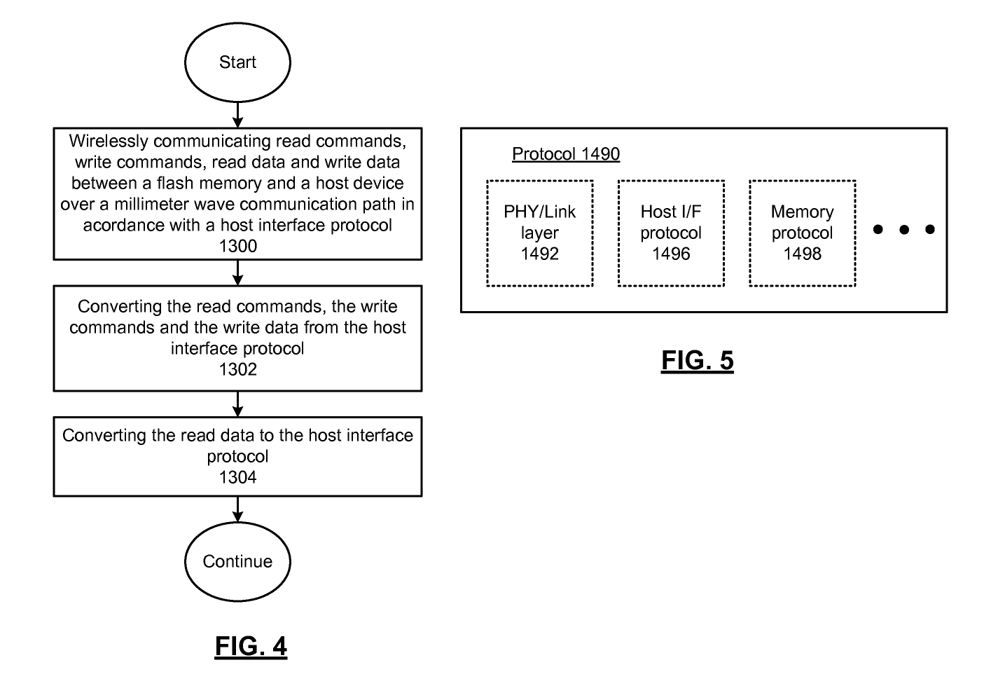

FIG. 4 presents a flowchart representation of a method in accordance with an embodiment of the present invention. In particular, a method is presented that can be used in conjunction with one or more of the features or functions described in association with FIGS. 1-3. In step 1300, read commands, write commands, read data and write data are wirelessly communicated between a flash memory and a host device over a millimeter wave communication path in accordance with a host interface protocol. In step 1302, the read commands, the write commands and the write data are converted from the host interface protocol. In step 1304, the read data are converted to the host interface protocol.

In an embodiment of the present invention, the host interface protocol includes at least one of: AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF), and operates in accordance with a protocol stack having a physical layer, a link layer, a command layer and a transport layer interface between the flash memory and the host device. The physical layer and the link layer can operate in accordance with a millimeter wave protocol.

FIG. 5 presents a block diagram representation of a protocol 1490 in accordance with an embodiment of the present invention. In particular, a protocol 1490 is illustrated that can be used in conjunction with millimeter wave transceiver 1218. This protocol 1490 contemporaneously operates in accordance with a plurality of different protocols, such as in a protocol stack or other multiple protocol arrangement that includes a physical layer, a link layer, a command layer and a transport layer. For instance, physical and link layer 1492 can operate over the millimeter wave communication path in accordance with a millimeter wave protocol. This millimeter wave protocol can carry a data payload via frames and/or packets with a header that includes control information. The data payload of the millimeter wave protocol can include data formatted in accordance with host interface protocol 1496 and memory protocol 1498 that cooperate to interface with a host device such as host device 49 in a format that is recognized by the host device and to transport data in accordance with read and write commands. It should be noted that a variety of different protocol structures can likewise be used to transfer data between host device 49 and dongle device 60.

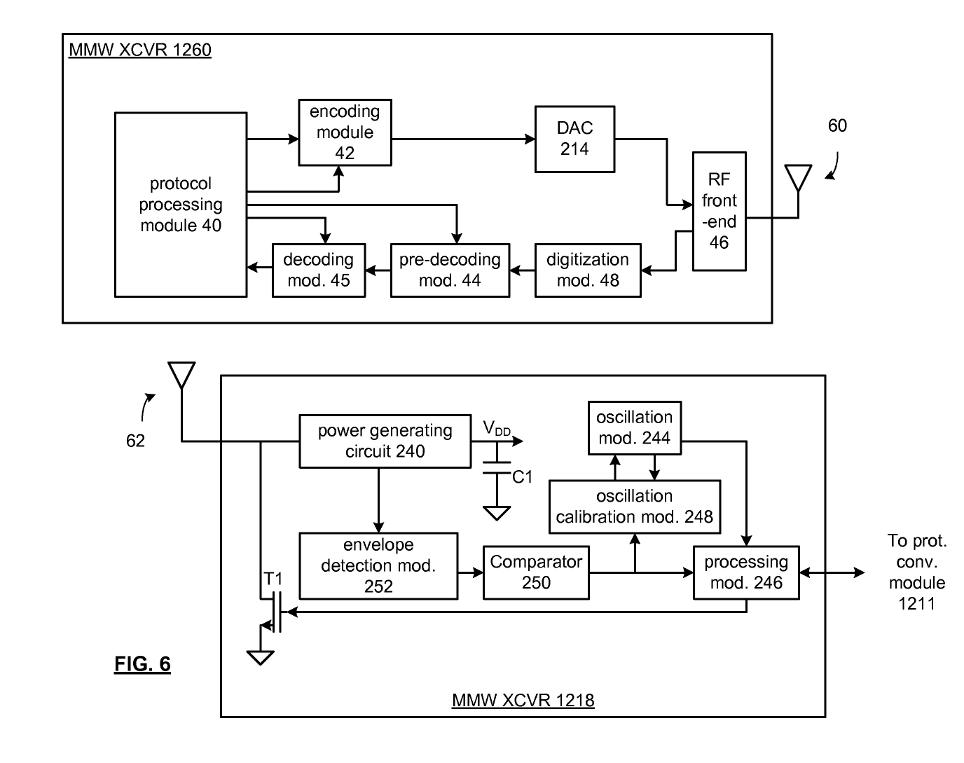

FIG. 6 presents a block diagram representation of millimeter wave transceivers in accordance with an embodiment of the present invention. As shown, millimeter wave transceiver 1260 includes a protocol processing module 40, an encoding module 42, an RF front-end 46, a digitization module 48, a predecoding module 44 and a decoding module 45, which together form components of the millimeter wave transceiver 1260. Millimeter wave transceiver 1260 optionally includes a digital-to-analog converter (DAC) 44.

The protocol processing module 40 is operably coupled to prepare data for encoding in accordance with a particular RFID standardized protocol that optionally carries a host interface protocol as previously discussed. In an exemplary embodiment, the protocol processing module 40 is programmed with multiple RFID standardized protocols to enable the millimeter wave transceiver 1260 to communicate with any millimeter wave transceiver, regardless of the particular protocol associated with the transceiver. In this embodiment, the protocol processing module 40 operates to program filters and other components of the encoding module 42, decoding module 45, pre-decoding module 44 and RF front end 46 in accordance with the particular RFID standardized protocol of the dongle devices 60 or other devices currently communicating with the millimeter wave transceiver 1260. However, if dongle devices 60 or other devices that may couple to millimeter wave transceiver 1260 operate in accordance with a single protocol, this flexibility can be omitted.

In operation, once the particular RFID standardized protocol has been selected for communication with one or more millimeter wave transceivers 1218, the protocol processing module 40 generates and provides digital data to be communicated to the millimeter wave transceiver 1218 to the encoding module 42 for encoding in accordance with the selected RFID standardized protocol. This digital data can include commands to power up the millimeter wave transceiver 1218, to issue read, write, erase and other commands and write data and/or data used by the dongle device 60 in association with its operation. By way of example, but not limitation, the RFID protocols may include one or more line encoding schemes, such as Manchester encoding, FM0 encoding, FM1 encoding, etc. Thereafter, in the embodiment shown, the digitally encoded data is provided to the digital-to-analog converter 44 which converts the digitally encoded data into an analog signal. The RF front-end 46 modulates the analog signal to produce an RF signal at a particular carrier frequency that is transmitted via antenna 60 to one or more dongle devices, such as dongle device 60.

The RF front-end 46 further includes transmit blocking capabilities such that the energy of the transmitted RF signal does not substantially interfere with the receiving of a backscattered or other RF signal received from one or more dongle devices via the antenna 60. Upon receiving an RF signal from one or more dongle devices, the RF front-end 46 converts the received RF signal into a baseband signal. The digitization module 48, which may be a limiting module or an analog-to-digital converter, converts the received baseband signal into a digital signal. The predecoding module 44 converts the digital signal into an encoded signal in accordance with the particular RFID protocol being utilized. The encoded data is provided to the decoding module 45, which recaptures data, such as user data 102 therefrom in accordance with the particular encoding scheme of the selected RFID protocol. The protocol processing module 40 processes the recovered data to identify the object(s) associated with the dongle device(s) and/or provides the recovered data to the server and/or computer for further processing.

The processing module 40 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 40 implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry.

Millimeter wave transceiver 1218 includes a power generating circuit 240, an oscillation module 244, a processing module 246, an oscillation calibration module 248, a comparator 250, an envelope detection module 252, a capacitor C1, and a transistor T1. The oscillation module 244, the processing module 246, the oscillation calibration module 248, the comparator 250, and the envelope detection module 252 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. One or more of the modules 244, 246, 248, 250, 252 may have an associated memory element, which may be a single memory device, a plurality of memory devices, and/or embedded circuitry of the module. Such a memory device may be a read-only memory, random access memory, volatile memory, non-volatile memory, static memory, dynamic memory, flash memory, cache memory, and/or any device that stores digital information. Note that when the modules 244, 246, 248, 250, 252 implement one or more of their functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry.

In operation, the power generating circuit 240 generates a supply voltage (V_{DD}) from a radio frequency (RF) signal that is received via antenna 254. The power generating circuit 240 stores the supply voltage V_{DD} in capacitor C1 and provides it to modules 244, 246, 248, 250, 252 and optionally to the other components of dongle device 60.

When the supply voltage V_{DD} is present, the envelope detection module 252 determines an envelope of the RF signal, which includes a DC component corresponding to the supply voltage V_{DD}. In one embodiment, the RF signal is an amplitude modulation signal, where the envelope of the RF signal includes transmitted data. The envelope detection module 252 provides an envelope signal to the comparator 250. The comparator 250 compares the envelope signal with a threshold to produce a stream of recovered data.

The oscillation module 244, which may be a ring oscillator, crystal oscillator, or timing circuit, generates one or more clock signals that have a rate corresponding to the rate of the RF signal in accordance with an oscillation feedback signal. For instance, if the RF signal is a 900 MHz signal, the rate of the clock signals will be n*900 MHz, where “n” is equal to or greater than 1.

The oscillation calibration module 248 produces the oscillation feedback signal from a clock signal of the one or more clock signals and the stream of recovered data. In general, the oscillation calibration module 248 compares the rate of the clock signal with the rate of the stream of recovered data. Based on this comparison, the oscillation calibration module 248 generates the oscillation feedback to indicate to the oscillation module 244 to maintain the current rate, speed up the current rate, or slow down the current rate.

The processing module 246 receives the stream of recovered data and a clock signal of the one or more clock signals. The processing module 246 interprets the stream of recovered data to determine a command or commands contained therein. The command may be to store data, update data, reply with stored data, verify command compliance, erase data, an acknowledgement, etc. If the command(s) requires a response, the processing module 246 provides a signal to the transistor T1 at a rate corresponding to the RF signal. The signal toggles transistor T1 on and off to generate an RF response signal that is transmitted via the antenna. In one embodiment, the millimeter wave transceiver 1218 utilizing a back-scattering RF communication. Note that the resistor R1 functions to decouple the power generating circuit 240 from the received RF signals and the transmitted RF signals.

The millimeter wave transceiver 1218 may further include a current reference (not shown) that provides one or more reference, or bias, currents to the oscillation module 244, the oscillation calibration module 248, the envelope detection module 252, and the comparator 250. The bias current may be adjusted to provide a desired level of biasing for each of the modules 244, 248, 250 and 252.

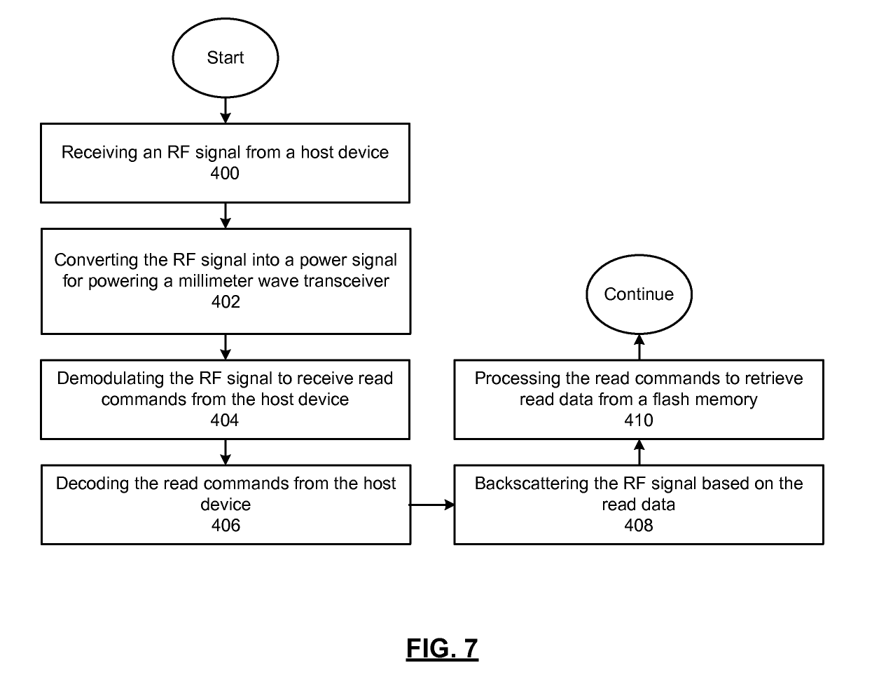

FIG. 7 presents a flowchart representation of a method in accordance with an embodiment of the present invention. In particular a method is presented for use with one or more of the functions and features described in conjunction with FIGS. 1-6. In step 400, an RF signal is received from a host device. In step 402, the RF signal is converted into a power signal for powering a millimeter wave transceiver. In step 404, the RF signal is demodulated to receive read commands from the host device. In step 406, the read commands from the host device are decoded. In step 408, the read commands are processed to retrieve read data from a flash memory. In step 410, the RF signal is backscattered based on read data.

In an embodiment of the present invention, the read commands and write commands are formatted in accordance with a host interface protocol that includes at least one of: direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

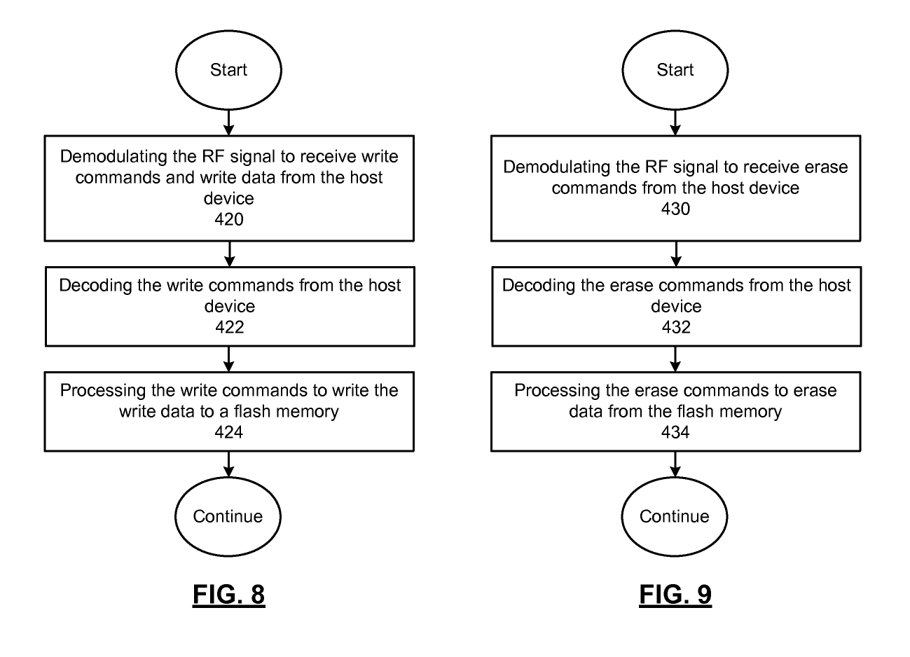

FIG. 8 presents a flowchart representation of a method in accordance with an embodiment of the present invention. In particular a method is presented for use with one or more of the functions and features described in conjunction with FIGS. 1-7. In step 420, the RF signal is demodulated to receive write commands, and write data from the host device. In step 422, write commands from the host device are decoded. In step 424, the write commands are processed to write the write data to the flash memory.

FIG. 9 presents a flowchart representation of a method in accordance with an embodiment of the present invention. In particular a method is presented for use with one or more of the functions and features described in conjunction with FIGS. 1-8. In step 430, the RF signal is demodulated to receive an erase command from the host device. In step 432, the erase command is decoded. In step 434, the erase command is processed to erase data from the flash memory.

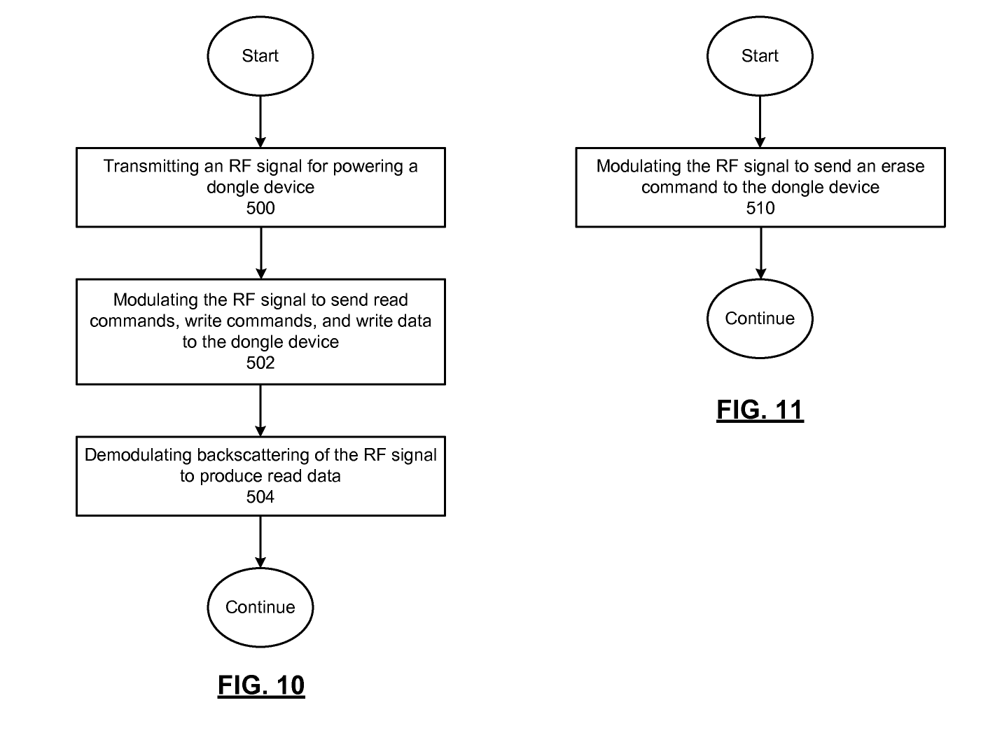

FIG. 10 presents a flowchart representation of a method in accordance with an embodiment of the present invention. In particular a method is presented for use with one or more of the functions and features described in conjunction with FIGS. 1-9. In step 500, an RF signal is transmitted for powering a dongle device. In step 502, the RF signal is modulated to send read commands, write commands, and write data to the dongle device. In step 504, backscattering of the RF signal is demodulated to produce read data.

As discussed in conjunction with FIG. 7, the read commands and write commands can be formatted in accordance with a host interface protocol that includes at least one of: direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

FIG. 11 presents a flowchart representation of a method in accordance with an embodiment of the present invention. In particular a method is presented for use with one or more of the functions and features described in conjunction with FIGS. 1-10. In step 510, the RF signal is modulated to send an erase command to the dongle device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A dongle device comprising:
a flash memory;
a millimeter wave transceiver coupled to:
receive an RF signal from a host device;
convert the RF signal into a power signal for powering the millimeter wave transceiver;
demodulate the RF signal to receive read commands, write commands, and write data from the host device; and
backscatter the RF signal based on read data; and
a host module coupled to decode the read commands and the write commands from the host device, to process the read commands to retrieve the read data from the flash memory and to process the write commands to write the write data to the flash memory.

2. The flash memory device of claim 1 wherein the host module includes a processing device to arbitrate the execution of read and write commands and the flow of data between the host interface module and the flash memory.

3. The flash memory device of claim 1 wherein the host module operates in accordance with a host interface protocol that includes at least one of: direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

4. The flash memory device of claim 1 wherein the millimeter wave transceiver is further coupled to demodulate the RF signal to receive an erase command from the host device, and wherein the host module is further coupled to decode the erase command, and process the erase commands to erase data from the flash memory.

5. An interface module that couples a dongle device to a host device, the host interface module including:
a millimeter wave transceiver coupled to:
transmit an RF signal for powering the dongle device;
modulate the RF signal to send read commands, write commands, and write data to the dongle device; and
demodulate backscattering of the RF signal to produce read data.

6. The interface module of claim 5 wherein the millimeter wave transceiver is further coupled to modulate the RF signal to send an erase command to the dongle device.

7. The interface module of claim 5 wherein the read commands and write commands are formatted in accordance a host interface protocol that includes at least one of: direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

8. A method for use in a dongle device comprising:
receiving an RF signal from a host device;
converting the RF signal into a power signal for powering a millimeter wave transceiver;
demodulating the RF signal to receive read commands from the host device;
decoding the read commands from the host device; and
processing the read commands to retrieve read data from a flash memory;
backscattering the RF signal based on read data;

9. The method of claim 8 further comprising:
demodulating the RF signal to receive write commands, and write data from the host device;
decoding write commands from the host device; and
processing the write commands to write the write data to the flash memory.

10. The method of claim 8 further comprising:
demodulating the RF signal to receive an erase command from the host device;
decoding the erase command; and
processing the erase command to erase data from the flash memory.

11. The method of claim 8 wherein the read commands and the write commands are formatted in accordance with a host interface protocol that includes at least one of: direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

12. A method for use in a host device, the method comprising
transmitting an RF signal for powering a dongle device;
modulating the RF signal to send read commands, write commands, and write data to the dongle device; and
demodulating backscattering of the RF signal to produce read data.

13. The method of claim 12 further comprising:
modulating the RF signal to send an erase command to the dongle device.

14. The method of claim 12 wherein the read commands and write commands are formatted in accordance with a host interface protocol that includes at least one of: direct memory access (DMA), AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).
